(19) United States
(12) Patent Application Publication
(10) Pub. No.: US 2007/0052883 A1
(43) Pub. Date: Mar. 8, 2007

(54) Light diffusing assembly

(75) Inventors: Mao-Song Lee, Hsin Chu City (TW); Hsi-Hsin Shih, Taichung City (TW); Shih-Kai Cheng, Yi Lan City (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: CHI LIN TECHNOLOGY CO., LTD., Jen Te Hsiang (TW)

(21) Appl. No.: 11/513,270

(22) Filed: Aug. 31, 2006

(30) Foreign Application Priority Data
Sep. 5, 2005 (CN) 200510098632.7

(51) Int. Cl. G02F 1/1335

(52) U.S. Cl. 349/64

(57) ABSTRACT

A light diffusing assembly includes: a diffuser plate exhibiting a light scattering effect; a brightness-enhancing sheet for enhancing brightness of light passing therethrough; and an intermedium sandwiched between and in face-to-face contact with the diffuser plate and the brightness-enhancing sheet and having a refractive index greater than air and less than that of the diffuser plate.

### CROSS-REFERENCE TO RELATED APPLICATION

This application claims priority of Chinese Application No. 200510098632.7, filed on Sep. 5, 2005.

### BACKGROUND OF THE INVENTION

1. Field of the Invention

This invention relates to a light diffusing assembly, more particularly to a light diffusing assembly having an intermedium sandwiched between a diffuser plate and a brightness-enhancing sheet.

2. Description of the Related Art

A backlight module is one of the key components of a liquid crystal display, and serves to provide a uniform light source for enabling the display of an image on a liquid crystal panel. Based on the disposition of the light source, backlight modules can be classified into a bottom lighting type and a side lighting type.

FIG. 1 illustrates a conventional light diffusing assembly 1 for a bottom lighting type backlight module. The conventional light diffusing assembly 1 includes a reflective base 13 having an open end, a diffuser plate 11 mounted on the open end of the reflective base 13 so as to define an accommodating space therebetween and having an incident surface 111 and an exit surface 112, a plurality of lamp tubes 12 mounted in the accommodating space, and a plurality of framed optical sheets 14, such as a brightness-enhancing sheet, a diffusing sheet, and optical sheets capable of reflecting and scattering light, spaced apart from the diffuser plate 11. The light emitted from the lamp tubes 12 is reflected by the reflective base 13 toward the diffuser plate 11, is subsequently scattered upon passing through the diffuser plate 11, and then passes through the optical sheets 14 so as to undergo a series of reflection, refraction, and scattering.

However, in order to avoid dust contamination, manufacture of the conventional light diffusing assembly 1 is required to be performed in a clean room, which results in higher production costs. Moreover, the presence of air between the diffuser plate 11 and the adjacent optical sheet 14 reduces the transmittance of the assembly of the diffuser plate 11 and the adjacent optical sheet 14.

### SUMMARY OF THE INVENTION

Therefore, the object of the present invention is to provide a light diffusing assembly that can overcome the aforesaid drawbacks of the prior art.

According to this invention, there is provided a light diffusing assembly that comprises: a diffuser plate exhibiting a light scattering effect; a brightness-enhancing sheet for enhancing brightness of light passing therethrough; and an intermedium sandwiched between and in face-to-face contact with the diffuser plate and the brightness-enhancing sheet and having a refractive index greater than air and less than that of the diffuser plate.

### BRIEF DESCRIPTION OF THE DRAWING

Other features and advantages of the present invention will become apparent in the following detailed description of the preferred embodiment of this invention, with reference to the accompanying drawing, in which:

FIG. 1 is a schematic partly sectional view of a conventional light diffusing assembly for a backlight module of a liquid crystal display;

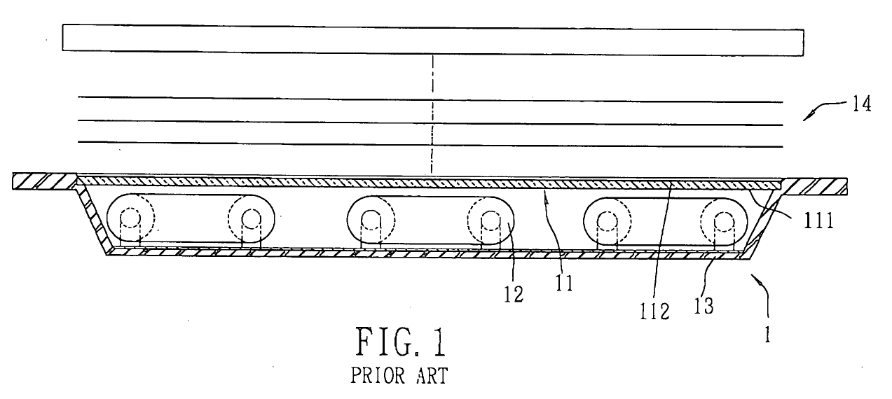

FIG. 2 is a schematic partly sectional view of the preferred embodiment of a light diffusing assembly for a backlight module of a liquid crystal display according to this invention; and

FIG. 3 is a fragmentary sectional view of the preferred embodiment.

### DETAILED DESCRIPTION OF THE PREFERRED EMBODIMENT

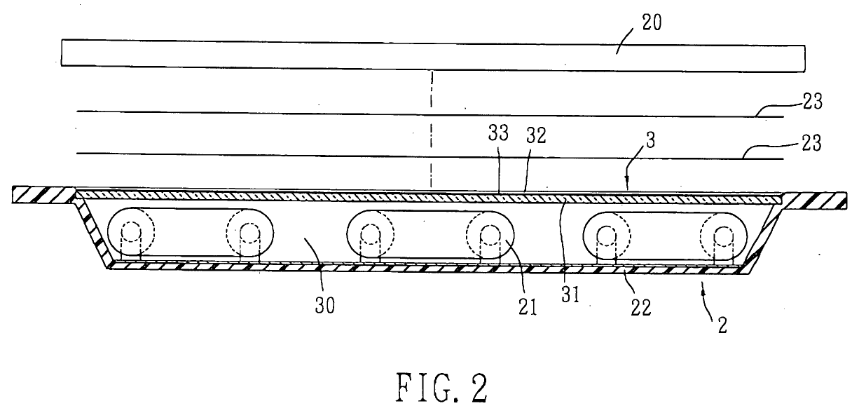

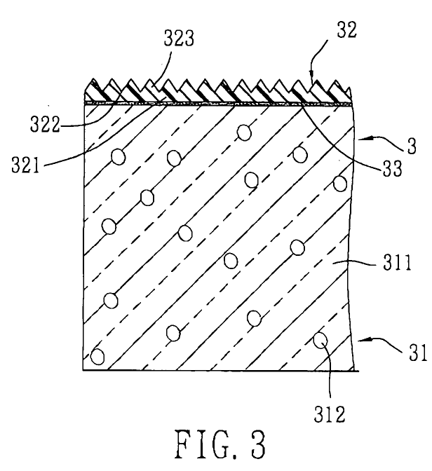

FIGS. 2 and 3 illustrate the preferred embodiment of a light diffusing assembly 3 for a backlight module 2, which serves to provide a uniform light source to be cast onto a liquid crystal panel 20 of a liquid crystal display according to this invention.

The backlight module 2 further includes a reflective base 22, a plurality of lamp tubes 21, and a plurality of optical sheets 23, such as a diffusing sheet and a brightness-enhancing sheet.

The light diffusing assembly 3 includes: a diffuser plate 31 that is mounted on an open end of the reflective base 22 so as to define an accommodating space 30 for mounting of the lamp tubes 21 therein, and that exhibits a light scattering effect; at least one brightness-enhancing sheet 32 for enhancing brightness of light passing therethrough; and an intermedium 33 sandwiched between and in face-to-face contact with the diffuser plate 31 and the brightness-enhancing sheet 23 and having a refractive index greater than air and less than that of the diffuser plate 31.

In this embodiment, the diffuser plate 31 includes a resinous matrix 311 and a plurality of diffusing particles 312 dispersed in the resinous matrix 311 and capable of scattering light passing therethrough. Preferably, the resinous matrix 311 has a refractive index of 1.6. Each of the diffusing particles 312 functions as a focusing lens. The materials for the resinous matrix 311 and the diffusing particles 312 are well known in the art and are commercially available. Hence, a detailed description of the same is omitted herein. Alternatively, instead of using the diffusing particles 312, the diffuser plate 31 can be formed with a plurality of alternately disposed protrusions and recesses (not shown) so as to achieve the diffusing effect.

The brightness-enhancing sheet 32 has a connecting portion 321 in face-to-face contact with the intermedium 33, and a roughened portion 322 extending from the connecting portion 321 in a direction away from the intermedium 33 and formed with a plurality of prism-shaped protrusions 323. The roughened portion 322 of the brightness-enhancing sheet 32 functions to enhance light extraction efficiency of the diffuser plate 31 by concentrating and collimating the light passing therethrough. Since the brightness-enhancing sheet 32 is well known in the art, a detailed description of the same is omitted herein.

Preferably, the intermedium 33 has a refractive index ranging from 1.33 to 1.6. More particularly, the intermedium 33 is preferably made from a material selected from the group consisting of water, glycerin, and optical adhesive.

The light diffusing assembly 3 can be made in a conventional manner by preparing the diffuser plate 31 and the brightness-enhancing sheet 32, coating the intermedium 33 on a surface of one of the diffuser plate 31 and the brightness-enhancing sheet 32, followed by pressing the assembly of the diffuser plate 31, the brightness-enhancing sheet 32, and the intermedium 33 to bond them together. The aforesaid coating operation can be conducted using a conventional roller coater or a conventional die coater. In order to prevent the intermedium 33 from leaking, a frame can be used to surround sealingly a periphery of the assembly of the diffuser plate 31, the brightness-enhancing sheet 32, and the intermedium 33.

The merits of the light diffusing assembly 3 of this invention will become apparent with reference to test results carried out in a conventional test method. The test results show that the light diffusing assembly 3 of this invention has a light diffusion rate of 66% and a light transmittance of 55% as compared to the aforesaid conventional light diffusing assembly which has a light diffusion rate of 61% and a light transmittance of 34%.

Hence, with the inclusion of the intermedium 33, which is sandwiched between and which is in face-to-face contact with the diffuser plate 31 and the brightness-enhancing sheet 32 and which has a refractive index greater than air and less than that of the diffuser plate 31, in the light diffusing assembly 3 of this invention, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A light diffusing assembly comprising:
a diffuser plate exhibiting a light scattering effect;
a brightness-enhancing sheet for enhancing brightness of light passing therethrough; and
an intermedium sandwiched between and in face-to-face contact with said diffuser plate and said brightness-enhancing sheet and having a refractive index greater than air and less than that of said diffuser plate.

2. The light diffusing assembly of claim 1, wherein said intermedium has a refractive index ranging from 1.33 to 1.6.

3. The light diffusing assembly of claim 1, wherein said intermedium is made from a material selected from the group consisting of water, glycerin, and optical adhesive.

4. The light diffusing assembly of claim 1, wherein said brightness-enhancing sheet has a connecting portion in face-to-face contact with said intermedium, and a roughened portion extending from said connecting portion in a direction away from said intermedium and formed with a plurality of protrusions.

5. The light diffusing assembly of claim 1, wherein said diffuser plate includes a resinous matrix and a plurality of diffusing particles dispersed in said resinous matrix, said resinous matrix having a refractive index higher than that of said intermedium.
